(19) United States
(12) Patent Application Publication
(10) Pub. No.: US 2026/0364462 A1
(43) Pub. Date: Nov. 19, 2026

(54) VIRTUAL ITEM-BASED INTERACTION METHOD

(71) Applicant: TENCENT TECHNOLOGY (SHENZHEN) COMPANY LIMITED, Shenzhen (CN)

(72) Inventor: Yijun WEI, Shenzhen (CN)

(73) Assignee: TENCENT TECHNOLOGY (SHENZHEN) COMPANY LIMITED, Shenzhen (CN)

(21) Appl. No.: 19/733,978

(22) Filed: Jul. 7, 2026

Related U.S. Application Data
(63) Continuation of application No. PCT/CN2025/084710, filed on Mar. 25, 2025.

(30) Foreign Application Priority Data
May 8, 2024 (CN) 202410565520.0

(51) Int. Cl. A63F 13/58

(52) U.S. Cl. CPC A63F 13/58

(57) ABSTRACT

In a virtual item-based interaction method, a first virtual item is displayed. An operation prompt is displayed while the first virtual item is dragged. The operation prompt indicates that a form change operation is supported while the first virtual item is dragged and indicates a trigger for the form change operation. A form of the first virtual item is changed based on the form change operation being triggered. The first virtual item is placed according to a changed form of the first virtual item. Apparatus and non-transitory computer-readable storage medium counterpart embodiments are also contemplated.

### CROSS-REFERENCE TO RELATED APPLICATIONS

The present application is a continuation of International Application No. PCT/CN2025/084710, filed on Mar. 25, 2025, which claims priority to Chinese Patent Application No. 202410565520.0, filed on May 8, 2024. The entire disclosures of the prior applications are hereby incorporated by reference.

### FIELD OF THE TECHNOLOGY

Embodiments of this disclosure relate to the field of man-machine interaction, including a virtual item-based interaction method and apparatus, a device, and a non-transitory computer-readable storage medium.

### BACKGROUND OF THE DISCLOSURE

In the game field, there are scenarios of changing positions of virtual items, such as placing a virtual item on a character into a game warehouse, and picking up a virtual item from a virtual airdrop box and placing the virtual item into a character backpack.

A PC game is provided in the related art. In this game, there is a need to change positions of virtual items in a warehouse. During a position change, a user needs to first click a state change option (“Rotate” option) to change an item form in a position of a virtual item, and after the form change, the user clicks the virtual item and drags the virtual item to another position by using a mouse.

The operation method for changing item positions provided in the related art is relatively cumbersome, resulting in low man-machine interaction efficiency.

### SUMMARY

Embodiments of this disclosure include a virtual item-based interaction method and apparatus, a device, and a non-transitory computer-readable medium, in which a position and a form of an item can be changed merely through one operation stage. Compared with multi-stage operations in the related art, the form and position of the virtual item can be changed more smoothly and accurately in this disclosure. Technical solutions of the embodiments of this disclosure may be implemented in the following manners.

An embodiment of this disclosure provides an virtual item-based interaction method. In the virtual item-based interaction method, a first virtual item is displayed. An operation prompt is displayed while the first virtual item is dragged. The operation prompt indicates that a form change operation is supported while the first virtual item is dragged and indicates a trigger for the form change operation. A form of the first virtual item is changed based on the form change operation being triggered. The first virtual item is placed according to a changed form of the first virtual item.

An embodiment of this disclosure provides an interaction processing apparatus. The interaction processing apparatus includes processing circuitry configured to display a first virtual item. The processing circuitry is configured to display an operation prompt while the first virtual item is dragged, the operation prompt indicating that a form change operation is supported while the first virtual item is dragged and indicating a trigger for the form change operation. The processing circuitry is configured to change a form of the first virtual item based on the form change operation being triggered. The processing circuitry is configured to place the first virtual item according to a changed form of the first virtual item.

An embodiment of this disclosure provides a non-transitory computer-readable storage medium storing instructions which when executed by a processor cause the processor to perform the virtual item-based interaction method.

According to an embodiment of this disclosure, a virtual item-based interaction method includes: displaying a first virtual item; displaying an operation prompt in a dragging process of the first virtual item, the operation prompt being configured for prompting that a form change operation is supported in the dragging process and prompting a shortcut of the form change operation; changing a form of the first virtual item in response to receiving the form change operation; and placing the first virtual item according to a changed form of the first virtual item after the dragging process ends.

According to another embodiment of this disclosure, a virtual item-based interaction apparatus includes: a display module, configured to display a first virtual item; the display module being further configured to display an operation prompt in a dragging process of the first virtual item, the operation prompt being configured for prompting that a form change operation is supported in the dragging process and prompting a shortcut of the form change operation; the display module being further configured to change a form of the first virtual item in response to receiving the form change operation; and a processing module, configured to place the first virtual item according to a changed form of the first virtual item after the dragging process ends.

According to an embodiment of this disclosure, a computer device includes a processor and a memory, the memory storing a computer program, the computer program being loaded and executed by the processor to implement the virtual item-based interaction method described above.

According to another embodiment of this disclosure, a non-transitory computer-readable storage medium is provided, storing a computer program, the computer program being loaded and executed by a processor to implement the virtual item-based interaction method described above.

According to another embodiment of this disclosure, a computer program product or a computer program is provided, the computer program product including computer instructions, the computer instructions being stored in a non-transitory computer-readable storage medium. A processor of a computer device reads the computer instructions from the non-transitory computer-readable storage medium, and executes the computer instructions, to cause the computer device to perform the virtual item-based interaction method provided in the foregoing embodiments.

The technical solutions provided in the embodiments of this disclosure can achieve at least the following beneficial effects.

In the embodiments of this disclosure, a user can perform a form change operation in a dragging process of a first virtual item. That is, in the solution provided in this disclosure, a position and a form of the first virtual item can be changed merely through one operation stage. Compared with multi-stage operations in the related art, the form and position of the first virtual item can be changed more smoothly and accurately in this disclosure.

In the related art, the user needs to change the form of the first virtual item in a first position before dragging the first virtual item to a second position, or the user needs to drag the first virtual item to the second position before changing the form of the first virtual item. However, in the former case, the first position may be incapable of matching a changed form of the first virtual item, and in the latter case, the second position is required to match the form of the first virtual item before the change. The related art has requirements on the positions before and after dragging, so that in some cases in which positions are limited, the user may be unable to place the first virtual item after a form change in the second position.

However, in the solution provided in this disclosure, the user can change the form of the first virtual item in the dragging process, without requiring the first position to match the changed form and without requiring the second position to match the form before the change. The solution provided in this disclosure is applicable to more common scenarios of changing positions of virtual items, and the user will encounter no obstacles when changing the position of the first virtual item.

In addition, in this disclosure, an operation prompt will be displayed in the dragging process of the first virtual item. In this disclosure, the operation prompt will be used to prompt the user that a form change operation can be performed in the dragging process, without the need for the user to explore the form change operation, thereby reducing the user's learning cost. In addition, in this disclosure, a shortcut of the form change operation will be displayed, without the need for the user to memorize the shortcut of the form change operation, thereby reducing the user's memory burden.

### BRIEF DESCRIPTION OF THE DRAWINGS

FIG. 1 is a schematic diagram of a character wearing region and a virtual warehouse according to an example embodiment.

FIG. 2 is a schematic diagram of a virtual item-based interaction process according to an example embodiment.

FIG. 3 is a schematic diagram of a computer system according to an example embodiment.

FIG. 4 is a flowchart of a virtual item-based interaction method according to an example embodiment.

FIG. 5 is a schematic diagram of an interface in an item dragging process according to an example embodiment.

FIG. 6 is a flowchart of a virtual item-based interaction method according to another example embodiment.

FIG. 7 is a flowchart of a virtual item-based interaction method according to another example embodiment.

FIG. 8 is a flowchart of a virtual item-based interaction method according to another example embodiment.

FIG. 9 is a flowchart of a virtual item-based interaction method according to another example embodiment.

FIG. 10 is a flowchart of a virtual item-based interaction method according to another example embodiment.

FIG. 11 is a schematic diagram of first two operations during warehouse organization according to an example embodiment.

FIG. 12 is a schematic diagram of last two operations during warehouse organization according to an example embodiment.

FIG. 13 is a flowchart of a virtual item-based interaction method according to an example embodiment.

FIG. 14 is a schematic diagram of first two operations during item adaptation according to an example embodiment.

FIG. 15 is a schematic diagram of last two operations during item adaptation according to an example embodiment.

FIG. 16 is a flowchart of a virtual item-based interaction method according to an example embodiment.

FIG. 17 is a schematic diagram of first two operations during item acquisition according to an example embodiment.

FIG. 18 is a schematic diagram of last two operations during item acquisition according to an example embodiment.

FIG. 19 is a flowchart of a virtual item-based interaction method according to an example embodiment.

FIG. 20 is a structural block diagram of a virtual item-based interaction apparatus according to an example embodiment.

FIG. 21 is a structural block diagram of a computer device according to an example embodiment.

### DETAILED DESCRIPTION

Examples of terms involved in the aspects of the disclosure are briefly introduced. The descriptions of the terms are provided as examples only and are not intended to limit the scope of the disclosure.

Virtual character: May be a movable object in a virtual environment. The movable object may be a virtual person, a virtual animal, a cartoon person, or the like, such as a person or an animal displayed in a 3D virtual environment. In some embodiments, the virtual character is a three-dimensional model created based on a skeletal animation technology. Each virtual character may have a respective shape and volume in the 3D virtual environment, and occupy some space in the 3D virtual environment.

Virtual item: May refer to a virtual item in a game, for example, a virtual backpack, virtual clothes, virtual equipment, or a virtual treatment kit. In some embodiments, virtual items are 3D items, and each virtual item has a respective shape and volume in the 3D virtual environment, and occupies some space in the 3D virtual environment.

In the game field, there may be scenarios of changing positions of virtual items, such as placing a virtual item on a virtual character into a game warehouse, and picking up a virtual item from a virtual airdrop box and placing the virtual item into a character backpack. In these scenarios, it may be necessary to change positions of virtual items. Generally, two container regions may be displayed on an interface. For example, one is a character wearing region of the virtual character and the other is the game warehouse. A virtual backpack may be dragged from the character wearing region to the game warehouse through a dragging operation, and vice versa.

In another example, one is a backpack storage region, and the other is the game warehouse. Candies, water, bandages, and the like are dragged from the backpack storage region to the game warehouse through dragging operations, and vice versa.

In this disclosure, a virtual item-based interaction method is provided.

In this disclosure, two methods for changing a position of a virtual item are provided as follows:
1. In one virtual container, a virtual item is moved from a first position to a second position.
2. In two virtual containers, a virtual item is moved from a first virtual container to a second virtual container. In some embodiments, virtual containers include a virtual warehouse, a character wearing region, a backpack storage region, a chest rig storage region, and the like. Virtual containers have storage capabilities.

FIG. 1 is a schematic diagram of a character wearing region 110 and a virtual warehouse 120 according to an example embodiment of this disclosure. Virtual items carried by a virtual character are displayed in the character wearing region 110. In some embodiments, during a battle, the virtual character may use the virtual items in the character wearing region 110.

Referring to FIG. 1, the character wearing region 110 includes a head equipment slot, a facial equipment slot, a main prop slot, a secondary prop slot, a headset slot, a bulletproof vest slot, a holster slot, a scabbard slot, a tactical chest rig slot, a backpack slot, a safety box slot, a key chain slot, and the like.

The head equipment slot is configured to accommodate head equipment such as a helmet and a hat.

The facial equipment slot is configured to accommodate facial protective equipment such as a mask, glasses, and a respirator.

The main prop slot is configured to accommodate a first long-range shooting prop, which is usually a handheld prop of the virtual character.

The secondary prop slot is configured to accommodate another long-range shooting prop, which is usually a prop carried on the back of the virtual character.

The headset slot is configured to accommodate a headset, for example, a tactical headset, which simulates a communication device used by the virtual character in gameplay.

The bulletproof vest slot is configured to accommodate a bulletproof vest worn by the virtual character.

The holster slot is configured to accommodate a short-range shooting prop, for example, a pistol.

The scabbard slot is configured to accommodate a melee prop, for example, a dagger.

The tactical chest rig slot is configured to accommodate a chest rig worn by the virtual character. In some embodiments, the chest rig further has a storage function. Referring to FIG. 1, in a case that the virtual character wears a chest rig, a chest rig storage region 130 will be displayed. The chest rig storage region 130 in FIG. 1 includes 8 sub-storage regions, and each of the 8 sub-storage regions includes 2 storage grids. In some embodiments, a storage capability of the chest rig is related to a type of the chest rig.

In this disclosure, a volume of a virtual item may be measured by a quantity of grids, and a shape of the virtual item may be measured by quantities of grids in the length direction and the width direction. For example, a volume of a standard surgical pack is 2 (occupying two grids), and a shape of the standard surgical pack is 1*2, or may be 2*1.

The backpack slot is configured to accommodate a backpack worn by the virtual character. The backpack has a storage function. Referring to FIG. 1, in a case that the virtual character wears a backpack, a backpack storage region 140 will be displayed. The backpack storage region 140 in FIG. 1 includes 4*4 storage grids. In some embodiments, a storage capability of the backpack is related to a type of the backpack.

The safety box slot is configured to accommodate a safety box carried by the virtual character. In some embodiments, the safety box has a storage function. In a case that the virtual character is equipped with a safety box, a safety box storage region (not shown in FIG. 1) will be displayed. In some embodiments, a storage capability of the safety box is related to a type of the safety box.

The key chain slot is configured to accommodate a key chain of the virtual character. In some embodiments, the key chain has a storage function. In a case that the virtual character is equipped with a key chain, a key chain storage region (not shown in FIG. 1) will be displayed.

The virtual warehouse 120 has a large-capacity storage capability. In some embodiments, in a battle, the virtual character may use the virtual items in the character wearing region 110, but may not use the virtual items in the virtual warehouse 120. In some embodiments, outside of a battle, a user may place the virtual items from the character wearing region 110 into the virtual warehouse 120, or place the virtual items from the virtual warehouse 120 into the character wearing region 110.

In some embodiments, the storage capability of the virtual warehouse 120 is measured by a quantity of grids. The virtual warehouse 120 in FIG. 1 includes 500 storage grids. A shape of the virtual warehouse 120 is 20*25, and the unit is a storage grid.

The game involved in this disclosure includes the following scenarios. Outside of a battle, the user drags a target item from the virtual warehouse 120 and places the target item in the character wearing region 110. The target item in the character wearing region 110 will be carried into the battle. The user may acquire other items and place the other items in the character wearing region 110 in the battle. In response to that the user completes the battle or wins the battle, the other items acquired in the battle will be taken out of the battle. The user may drag the other items acquired in the battle from the character wearing region 110 and place the other items in the virtual warehouse 120.

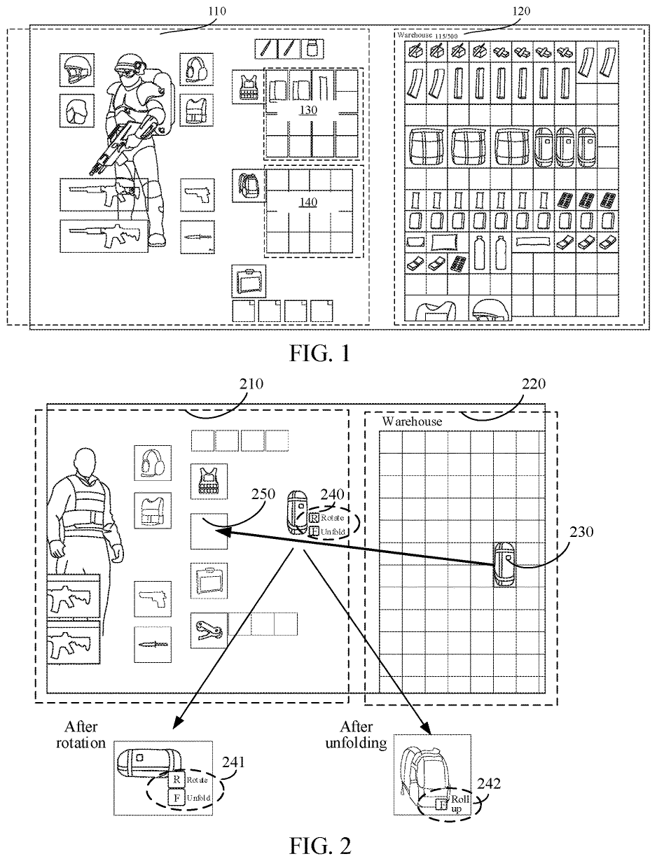

FIG. 2 is a schematic diagram of a virtual item-based interaction process according to an example embodiment of this disclosure. FIG. 2 shows a character wearing region 210 and a virtual warehouse 220.

Referring to FIG. 2, a virtual backpack 230 in the virtual warehouse 220 is in a rolled-up form. The backpack in the rolled-up form has a shape of 1*2, and each unit is a storage grid. In response to that the virtual backpack 230 receives a dragging operation, an operation prompt 240 will be displayed in a dragging process of the virtual backpack 230. The operation prompt 240 prompts that the virtual backpack 230 supports a rotation operation in the dragging process, and that the virtual backpack 230 can be quickly rotated by using an “R” key on a keyboard. The operation prompt 240 further prompts that the virtual backpack 230 supports an unfolding operation in the dragging process, and that the virtual backpack 230 can be quickly unfolded by using an “F” key on the keyboard.

FIG. 2 shows a form of the virtual backpack 230 after rotation. In this case, compared with the form before rotation, the virtual backpack 230 has been rotated 90 degrees counterclockwise. A rotation direction and a rotation angle of the rotation operation may be set by a system or by the user. In this disclosure, a counterclockwise rotation of 90 degrees is merely used as an example. In addition, the virtual backpack 230 after the rotation remains the rolled-up state.

After the rotation, an updated operation prompt 241 will be displayed. The updated operation prompt 241 is configured for prompting that the virtual backpack 230 supports a rotation operation in the dragging process, and that the virtual backpack 230 can be quickly rotated by using the “R” key on the keyboard. The updated operation prompt 241 is further configured for prompting that the virtual backpack 230 supports an unfolding operation in the dragging process, and that the virtual backpack 230 can be quickly unfolded by using the “F” key on the keyboard.

FIG. 2 shows a form of the virtual backpack 230 after unfolding. In this case, the virtual backpack 230 is in an unfolded form. The virtual backpack in the unfolded form has a shape of 4*4, and each unit is a storage grid.

After the unfolding, another updated operation prompt 242 will be displayed. The another updated operation prompt 242 is configured for prompting that the virtual backpack 230 supports a roll-up operation in the dragging process, and that the virtual backpack 230 can be quickly rolled up by using the “F” key on the keyboard. In this disclosure, the unfolded virtual backpack is designed as a square and its direct rotation performance is not good, so that the unfolded virtual backpack can be no longer rotated, while after the virtual backpack in the rolled-up form is rotated, a rotation operation prompt will still be displayed.

Referring to FIG. 2, in response to that the virtual backpack 230 is dragged to a backpack slot 250, the virtual backpack 230 is worn on the virtual character. In some embodiments, if the virtual backpack 230 is not dragged to the backpack slot 250, the operation of moving the virtual backpack 230 this time is abandoned. In some embodiments, in response to that the virtual backpack 230 is dragged to the backpack slot 250, the virtual backpack 230 will automatically be in the unfolded form and a backpack storage region will be displayed.

In some embodiments, the virtual backpack 230 is displayed in a fixed form in the backpack slot 250, that is, a form change operation in the dragging process will not affect the backpack form displayed in the backpack slot 250.

In some embodiments, in response to that the virtual backpack 230 is dragged to the backpack slot 250, a form of the virtual backpack 230 in the backpack slot 250 is determined according to the form of the virtual backpack 230 when the dragging ends. If the virtual backpack 230 is in the rolled-up form when the dragging ends, the backpack storage region is not displayed; and if the virtual backpack 230 is in the unfolded form when the dragging ends, the backpack storage region is automatically displayed.

In the dragging process of the first virtual item, the user may perform a form change operation. That is, in the solution provided in this disclosure, a position and a form of the first virtual item can be changed merely through one operation stage. Compared with multi-stage operations in the related art, the form and position of the first virtual item can be changed more smoothly and accurately in this disclosure.

In addition, an operation prompt will be displayed in the dragging process of the first virtual item. In this disclosure, the operation prompt will be used to prompt the user that a form change operation can be performed in the dragging process and prompt a shortcut of the form change operation, without the need for the user to explore the form change operation, thereby reducing the user's learning cost.

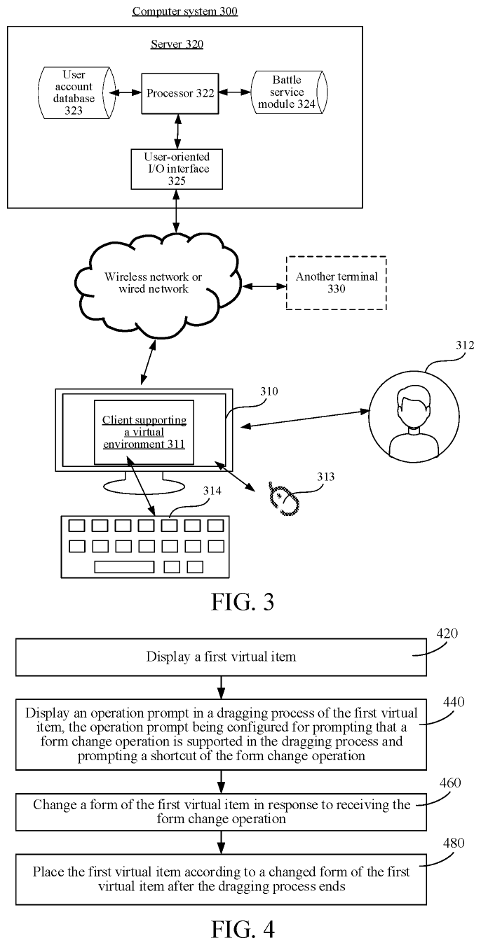

FIG. 3 is a structural block diagram of a computer system according to an example embodiment of this disclosure. The computer system 300 includes a first terminal 310, a server 320, and another terminal 330.

A client 311 supporting a virtual environment is installed and run on the first terminal 310, and the client 311 may be a game client. In some embodiments, the game client is a PC game. When the first terminal 310 runs the client 311, a user interface of the client 311 is displayed on a screen of the first terminal 310. The first terminal 310 is a terminal used by a first user 312. The first user 312 uses the first terminal 310 to change a position of a virtual item through a first external device (which is a mouse in some embodiments) 313 and a second external device (which is a keyboard in some embodiments) 314. For example, a virtual backpack in a warehouse is dragged and placed in a character wearing region through the first external device 313, and a form of the virtual backpack is changed through the second external device 314 in the dragging process.

In some embodiments, the device type of the first terminal 310 includes at least one of the following: a desktop computer, a laptop portable computer, a smart TV, a smartphone, a wearable device, an in-vehicle terminal, or a tablet computer. In the following embodiments, a description is provided by using an example in which the terminal includes a desktop computer.

A person skilled in the art may learn that there may be more or fewer terminals. For example, there may be only one terminal (that is, the user plays against artificial intelligence), or there are six, eight, or more terminals. The quantity and the device type of the terminals are not limited in the embodiments of this disclosure.

FIG. 3 shows only one terminal. However, a plurality of other terminals 330 may access the server 320 in different embodiments. In some embodiments, one or more terminals 330 are terminals corresponding to a developer. A developing and editing platform for the client supporting a virtual environment is installed on the terminal 330. The developer may edit and update the client on the terminal 330 and transmit an updated client installation package to the server 320 by using a wired or wireless network. The first terminal 310 may download the client installation package from the server 320 to update the client.

The first terminal 310 and the another terminal 330 are connected to the server 320 by using a wireless network or a wired network.

The server 320 includes at least one of one server, a plurality of servers, a cloud computing platform, and a virtualization center. The server 320 is configured to provide a background service for a client supporting a virtual environment. In some embodiments, the server 320 takes on primary computing work, and the terminals take on secondary computing work. Alternatively, the server 320 takes on secondary computing work, and the terminals take on primary computing work. Alternatively, collaborative computing is performed by using a distributed computing architecture between the server 320 and the terminals.

In a schematic example, the server 320 includes a processor 322, a user account database 323, a battle service module 324, and a user-oriented input/output (I/O) interface 325. The processor 322 is configured to load instructions stored in the server 320, and process data in the user account database 323 and the battle service module 324. The user account database 323 is configured to store data of user accounts used by the first terminal 310 and the another terminal 330, for example, profile pictures of the user accounts, nicknames of the user accounts, gameplay performance indices of the user accounts, and service regions in which the user accounts are located. The battle service module 324 is configured to provide a plurality of battle rooms to users for a battle. The user-oriented I/O interface 325 is configured to establish communication with the first terminal 310 through a wireless network or wired network to exchange data.

Information (including but not limited to user device information, user personal information, and the like), data (including but not limited to data used for analysis, stored data, displayed data, and the like) and signals involved in this disclosure are authorized by the user or fully authorized by all parties, and the collection, use and processing of relevant data need to comply with relevant laws, regulations and standards of relevant countries and regions. For example, item information and the like involved in this disclosure are all acquired under full authorization.

In addition, when it comes to relevant information, the relevant information processor will follow the principles of legality, legitimacy, and necessity, determine the objective, method, and scope of the relevant information processing, obtain the permission of the relevant information subject, and take necessary technical and organizational measures to ensure the security of the relevant information.

FIG. 4 is a flowchart of a virtual item-based interaction method according to an example embodiment of this disclosure. A description is provided by using an example in which the method is performed by the first terminal 310 shown in FIG. 3. The method includes the following operations:
Operation 420: Display a first virtual item.

The first virtual item refers to an item that can be accommodated in the game. That is, the first virtual item refers to an item that can be placed in a container. In some embodiments, the first virtual item is in a container and represented in a form of an icon, a 3D model, text, or the like. In some embodiments, the first virtual item includes a backpack, game equipment, a treatment prop, a signal gun, a currency, a key, a special task prop, a fruit, a cuisine, a potion, and the like.

In some embodiments, the first virtual item may be placed in a game warehouse, a character wearing region, a backpack storage region, a chest rig storage region, a safety box storage region, a box in a game scene, a shelf, and the like, all of which may be referred to as containers.

For example, a first virtual item in the virtual warehouse is displayed. In some embodiments, a capacity of the virtual warehouse is measured by a quantity of storage grids. For example, the capacity of the virtual warehouse is 20*25 storage grids. In some embodiments, the first virtual item is an item that occupies a certain volume. The volume of the first virtual item is measured by a quantity of occupied storage grids. For example, the volume of the first virtual item is 1*2, meaning that a length of the first virtual item is 1 storage grid and a width thereof is 2 storage grids; or the volume of the first virtual item is 2*1, meaning that the length of the first virtual item is 2 storage grids and the width thereof is 1 storage grid. The two cases both indicate that the volume of the first virtual item is 2 (two storage grids).

For example, a first virtual item in the character wearing region is displayed. In some embodiments, the character wearing region includes a plurality of equipment slots, such as a head equipment slot, a facial equipment slot, a main prop slot, a secondary prop slot, a headset slot, a bulletproof vest slot, a holster slot, a scabbard slot, a tactical chest rig slot, a backpack slot, a safety box slot, and a key chain slot. In some embodiments, volumes of items in the equipment slots are not calculated. In some embodiments, in a case that a backpack is placed in the backpack slot, a backpack storage region will be displayed. A capacity of the backpack storage region is measured by a quantity of storage grids. For example, the capacity of the backpack storage region is 4*4, and each unit is a storage grid.

For example, a first virtual item in a supply crate appearing after refresh in a battle is displayed. In some embodiments, a capacity of the supply crate is measured by a quantity of storage grids. For example, the capacity of the supply crate is 10*10 storage grids.
Operation 440: Display an operation prompt in a dragging process of the first virtual item, the operation prompt being configured for prompting that a form change operation is supported in the dragging process and prompting a shortcut of the form change operation. In an example, an operation prompt is displayed while the first virtual item is dragged. In the example, the operation prompt indicates that a form change operation is supported while the first virtual item is dragged and indicates a trigger for the form change operation.

In the game, there are needs to change a position of the first virtual item. These needs may be divided into two types as follows:
1. A first virtual item in a first container is placed into a second container through a dragging operation. For example, a first virtual item in the virtual warehouse is dragged and placed into the character wearing region.
2. A first virtual item in a first position in a container is placed in a second position in the container through a dragging operation. For example, a first virtual item in a first position in the virtual warehouse is dragged and placed in a second position in the virtual warehouse (to achieve the objective of warehouse organization).

In another example, a first virtual item in a first position in the backpack storage region is dragged and placed in a second position in the backpack storage region (to achieve the objective of backpack storage region organization).

In some aspects of this disclosure, only the dragging process of the first virtual item is considered, and the container/position in which the first virtual item is located before dragging and the container/position in which the first virtual item is located after dragging are not limited. That is, the method provided in this disclosure is applicable to all the scenarios of changing the position of the first virtual item above.

In an embodiment, in the dragging process, a first external device connected to the first terminal in a wired or wireless manner is used to drag the first virtual item. In some embodiments, the first external device includes a mouse, a virtual reality (VR)/augmented reality (AR) device, a gesture sensing device, and the like. The mouse is used as an example. First, a cursor is controlled to fall on the first virtual item. In response to that a left mouse button receives a click operation, it is determined that the first virtual item is selected. Through continuous movement of the cursor, the first virtual item is controlled to move with the cursor, thereby realizing a dragging operation.

The form change operation includes a rotation operation, an unfolding operation, a compression operation, and the like. In some embodiments, the category of the form change operation is related to the type of the first virtual item. For example, for virtual items that support the unfolding/compression operation, the unfolding/compression operation can be performed in the dragging process, such as a virtual backpack, clothes, and a chest rig.

The rotation operation refers to an operation that changes a rotational form of an item, for example, rotating an upright backpack to obtain a lying-flat backpack. The unfolding operation refers to an operation that changes an item from a compressed form to an unfolded form, such as unfolding a rolled-up backpack or unfolding folded clothes. The compression operation refers to an operation that changes an item from an unfolded form to a compressed form, such as rolling up an unfolded backpack or folding unfolded clothes. In some embodiments, the compression operation includes a roll-up operation (for example, an operation of rolling up a backpack) and a folding operation (for example, an operation of folding clothes).

The operation prompt is configured for prompting that a form change operation is supported in the dragging process and prompting a shortcut of the form change operation. The shortcut refers to a manner of pressing a shortcut key on a keyboard in some embodiments. For example, the rotation operation may be triggered by pressing an “R” key on the keyboard; and the unfolding/compression operation may be triggered by pressing an “F” key on the keyboard. In some embodiments, the shortcut keys are preset by a game system or user-defined.

In some embodiments, the operation prompt includes at least one element of text and a pattern. In some embodiments, the operation prompt has at least one of the following attributes: color, border, flashing effect, shape, size, brightness, and transparency.

In an embodiment, the operation prompt is presented in a flashing state, and the operation prompt in the flashing state is more likely to attract the user's attention. In an embodiment, the operation prompt is presented in a highlighted state, and the operation prompt in the highlighted state is more likely to attract the user's attention. In an embodiment, the operation prompt has a border, and the operation prompt having the border is more likely to attract the user's attention.

In an embodiment, the operation prompt includes a text region and a pattern region. The text region is configured for prompting a form change operation supported in the dragging process, and the pattern region is configured for prompting a shortcut of the form change operation.

For example, referring to FIG. 2, the operation prompt 240 in FIG. 2 includes a text region. Text “Rotate” is displayed in the text region, configured for prompting that a rotation operation is supported in the dragging process, and text “Unfold” is further displayed in the text region, configured for prompting that an unfolding operation is supported in the dragging process. The operation prompt 240 in FIG. 2 further includes a pattern region. A key “R” is displayed in the pattern region, configured for prompting that the rotation operation can be triggered by pressing the “R” key on the keyboard, and a key “F” is further displayed in the pattern region, configured for prompting that the unfolding operation can be triggered by pressing the “F” key on the keyboard.

In an embodiment, the operation prompt moves along with dragging of the first virtual item. That is, there is no relative movement between the operation prompt and the first virtual item. The operation prompt is located near the first virtual item. In some embodiments, the operation prompt is located at the upper part, at the lower part, at the left side, at the right side, in the upper left corner, in the upper right corner, in the lower left corner, in the lower right corner, or the like of the first virtual item. In FIG. 2, the operation prompt 240 is located in the lower right corner of the first virtual item.

In some embodiments, the operation prompt is adaptively displayed near the first virtual item in the dragging process. For example, under normal circumstances, the operation prompt will be displayed in the lower right corner of the first virtual item. If the operation prompt overlaps with other visible elements in the dragging process, the operation prompt will be displayed in the lower left corner of the first virtual item.

In the foregoing embodiment, the operation prompt is located near the first virtual item and moves with the first virtual item, which helps the user to form an integrated perception of the operation prompt and the first virtual item. The user may need to focus primarily on one region on the screen, and does not need to pay attention to the operation prompt and the first virtual item separately.
Operation 460: Change a form of the first virtual item in response to receiving the form change operation.

In an embodiment, before the form change operation is received, the first virtual item displays a folded form. In response to receiving an unfolding operation, the first virtual item in the unfolded form is displayed.

In an embodiment, before the form change operation is received, the first virtual item displays an unfolded form. In response to receiving a folding operation, the first virtual item in the folded form is displayed.

In an embodiment, before the form change operation is received, the first virtual item displays a first rotational form (for example, an upright backpack). In response to receiving a rotation operation, the first virtual item in a second rotational form (for example, a lying-flat backpack) is displayed.

In an embodiment, the operation prompt is updated as the form of the first virtual item changes. For example, before the form change, an unfolding operation prompt is displayed; and in response to receiving an unfolding operation, the first virtual item in the unfolded form is displayed, and a folding operation prompt is displayed.

For example, before the form change, a folding operation prompt is displayed; and in response to receiving a folding operation, the first virtual item in the folded form is displayed, and an unfolding operation prompt is displayed.

That is, the operation prompt is updated in real time according to the form of the first virtual item.

In an embodiment, in the dragging process of the first virtual item, a quantity of times of form changes is not limited. That is, there is a case in which the user continuously changes the form of the first virtual item before the user stops the dragging operation.

In another embodiment, in the dragging process of the first virtual item, the user may perform a limited quantity of times of form change operations. For example, the user may change the form of the first virtual item once.

In an embodiment, in the dragging process, on an interface, the form of the first virtual item will be displayed in real time, and a target container (a container intended to place the first virtual item) will be displayed. The target container is divided by grids, and the form of the first virtual item may also be represented by grids. Therefore, in the dragging process, the user may observe degrees of adaptation between various item forms and the target container in real time, and finally place the first virtual item in an expected position of the target container. Meanwhile, before the dragging operation ends, the user can perceive a result after the dragging ends.

For example, if the user intends to roll up a 4*4 virtual backpack in the character wearing region and place the virtual backpack in a 1*2 empty region of the virtual warehouse, the user may perform form switching and position adjustment on the backpack according to an operation prompt displayed in real time in the dragging process, and finally accurately place the item in an expected position.

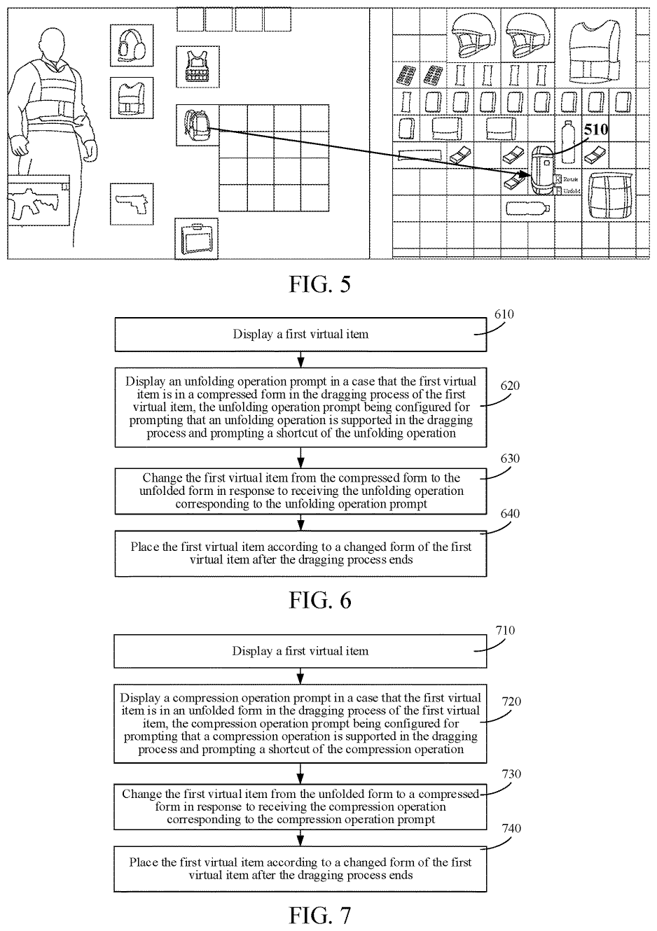

FIG. 5 shows a process of dragging a virtual backpack 510 from the character wearing region to the virtual warehouse. Before the dragging, the virtual backpack 510 is in the unfolded form, and the virtual backpack 510 has a shape of 4*4, with a unit of a storage grid. The user performs a roll-up operation in the dragging process, and the shape of the virtual backpack 510 changes to 1*2, with a unit of a storage grid. In the dragging process, the user observes that a certain empty region in the virtual warehouse is exactly 1*2 in size, so that the user drags the virtual backpack 510 and places the virtual backpack in the empty region. The empty region refers to a region accommodating no items.
Operation 480: Place the first virtual item according to a changed form of the first virtual item after the dragging process ends.

In an embodiment, in response to that the dragging operation ends in a container region, the first virtual item is placed in the container region according to the changed form of the first virtual item.

In some embodiments, in response to that the dragging operation ends in an empty region in a container, the first virtual item is placed in the empty region according to the changed form of the first virtual item.

In some embodiments, the first virtual item is placed according to the form of the first virtual item when the dragging operation ends. In some embodiments, in response to that the dragging operation ends in a non-container region or a non-empty region in a container, the operation of placing the first virtual item this time is abandoned.

Based on the above, an operation prompt is displayed in the dragging process of the first virtual item. In this disclosure, the operation prompt will be used to prompt the user that a form change operation can be performed in the dragging process and prompt a shortcut of the form change operation, without the need for the user to explore the form change operation, thereby reducing the user's learning cost.

Based on the optional embodiment shown in FIG. 4, operation 420 may be replaced by: displaying a first virtual item in a first container. Operation 480 may be replaced by: placing the first virtual item in a second container according to the changed form of the first virtual item after the dragging process ends.

In an embodiment, capacities of the first container and the second container are both measured by a quantity of grids, and each container includes a plurality of grids; and a volume of the first virtual item is measured by a quantity of grids, and when the first virtual item is in the placed state, the first virtual item occupies at least one grid.

In some embodiments, the first container is a storage space of a third virtual item, the third virtual item is a virtual item with a storage capability, and the second container is a storage space designed by a game system. For example, the first container is the backpack storage region (in this case, a third virtual item is a backpack), the chest rig storage region (in this case, the third virtual item is a chest rig), or the like, and the second container is the virtual warehouse.

In some embodiments, the second container is a storage space of a third virtual item, the third virtual item is a virtual item with a storage capability, and the first container is a storage space designed by a game system. For example, the second container is the backpack storage region (in this case, the third virtual item is a backpack), the chest rig storage region (in this case, the third virtual item is a chest rig), or the like, and the first container is the virtual warehouse.

In another embodiment, the first container is a slot dedicated for items of a first category, and the first virtual item belongs to the first category. A capacity of the second container is measured by a quantity of grids, and the second container includes a plurality of grids. A volume of the first virtual item is measured by a quantity of grids, and when the first virtual item is in the placed state, the first virtual item occupies at least one grid.

For example, the first container is a head equipment slot, a facial equipment slot, a main prop slot, a secondary prop slot, a headset slot, a bulletproof vest slot, a holster slot, a scabbard slot, a tactical chest rig slot, a backpack slot, a safety box slot, a key chain slot, or the like, and the second container is a virtual warehouse, a virtual supply crate, or the like.

Based on the optional embodiment shown in FIG. 4, operation 440 may be replaced by S1 as follows, and operation 460 may be replaced by S2 as follows.
S1: Display n operation prompts corresponding to a first form in the dragging process of the first virtual item, the n operation prompts being configured for prompting that n form change operations are supported in the dragging process and prompting shortcuts in a one-to-one correspondence with the n form change operations, n being a positive integer.

The first form refers to the form of the first virtual item before the form change. In some embodiments, the first form includes a compressed/unfolded form. In some embodiments, the first form includes a first rotational form. In some embodiments, the first form includes the first rotational form and the compressed/unfolded form. The first rotational form refers to a rotational posture of the first virtual item before rotation; and the first rotational form is configured for representing that the first virtual item is in a rotatable state.

For example, for items that only support a rotation operation and do not support an unfolding/compression operation, the first form includes the first rotational form. For example, for a treatment prop, a currency, a key, a special task prop, a fruit, a cuisine, and a potion, only the rotation operation may be supported, while the unfolding/compression operation may not be supported.

For example, for items that support both of the rotation operation and the compression/unfolding operation, the first form includes the first rotational form and the compressed/unfolded form. For example, for a backpack, the backpack can support the rotation operation, and can also support the compression/unfolding operation.

For example, for items that only support the compression/unfolding operation and do not support the rotation operation, the first form includes the compressed/unfolded form. For example, for a water storage pocket, the water storage pocket may support the compression/unfolding operation, and may not support the rotation operation.

In this embodiment, n corresponding operation prompts will be displayed according to the first form of the first virtual item. For example, the first virtual item is in the first rotational form and the compressed form, then a rotation operation prompt and an unfolding operation prompt will be displayed.
S2: Change the first virtual item from the first form to a second form in response to receiving any one of the n form change operations.

The second form refers to a form of the first virtual item after the form change. In some embodiments, the second form includes the compressed/unfolded form. In some embodiments, the second form includes the second rotational form. In some embodiments, the second form includes the second rotational form and the compressed/unfolded form. The second rotational form refers to a rotational posture of the first virtual item after rotation; and the second rotational form is configured for representing that the first virtual item is in a rotatable state.

In an embodiment, the first virtual item is changed from the first form to a second form in response to receiving any one of the n form change operations, and m operation prompts are displayed, the m operation prompts being configured for prompting that m form change operations are supported in the dragging process and prompting shortcuts in a one-to-one correspondence with the m form change operations, m being a positive integer. In addition, the m operation prompts correspond to the second form. That is, in the foregoing embodiment, the m corresponding operation prompts will be displayed according to the second form of the first virtual item.

That is, the operation prompt in this embodiment is updated in real time.

Based on the above, in the foregoing embodiment, a form change operation that can be currently performed by the user will be determined according to the real-time form of the first virtual item. Once the form of the first virtual item changes, the form change operation that can be performed by the user will be re-determined. The real-time operation prompt allows the user to quickly understand the form change operation that can be used after the form of the item changes in the dragging process.

FIG. 6 is a flowchart of a virtual item-based interaction method according to an example embodiment of this disclosure. A description is provided by using an example in which the method is performed by the first terminal 310 shown in FIG. 3. The method includes the following operations:
Operation 610: Display a first virtual item.
Operation 620: Display an unfolding operation prompt in a case that the first virtual item is in a compressed form in the dragging process of the first virtual item, the unfolding operation prompt being configured for prompting that an unfolding operation is supported in the dragging process and prompting a shortcut of the unfolding operation.

For example, a cursor of a mouse is controlled to fall on the first virtual item. In response to that a left mouse button receives a click operation, it is determined that the first virtual item is selected. Through continuous movement of the cursor, the first virtual item is controlled to move with the cursor. In the process in which the first virtual item moves along with movement of the cursor, the first virtual item may be in the compressed form. For example, a virtual backpack is in a rolled-up form or virtual clothes are in a folded form.

For the first virtual item in the compressed form, an unfolding operation prompt will be displayed on the interface. The unfolding operation prompt is configured for prompting that an unfolding operation is supported in the dragging process and prompting a shortcut of the unfolding operation. That is, this embodiment provides a real-time operation prompt. The operation prompt will change in real time based on the form of the first virtual item. The first virtual item is in the compressed form, then the unfolding operation prompt is displayed.

In an embodiment, the unfolding operation prompt includes an unfolding text region and an unfolding pattern region. The unfolding text region is configured for prompting that an unfolding operation is supported in the dragging process, and the unfolding pattern region is configured for prompting a shortcut of the unfolding operation. For example, text “Unfold” is displayed in the unfolding text region, indicating that the unfolding operation is supported in the dragging process. A key “F” is displayed in the unfolding pattern region, indicating that the unfolding operation can be triggered by pressing the “F” key on the keyboard.

In an embodiment, the unfolding operation prompt moves along with dragging of the first virtual item, and the unfolding operation prompt is located near the first virtual item. In some embodiments, the unfolding operation prompt is located at the upper part, at the lower part, at the left side, at the right side, in the upper left corner, in the upper right corner, in the lower left corner, in the lower right corner, or the like of the first virtual item.

In an embodiment, the unfolding operation prompt includes an unfolding operation animation, for example, playing an animation of pressing the “F” key on the keyboard with a finger to unfold a backpack in the compressed form.
Operation 630: Change the first virtual item from the compressed form to the unfolded form in response to receiving the unfolding operation corresponding to the unfolding operation prompt.

For example, in response to receiving an operation of triggering the “F” key on the keyboard, the virtual backpack is changed from the rolled-up form to the unfolded form.

For example, in response to receiving an operation of triggering the “F” key on the keyboard, the virtual clothes are changed from the folded form to the unfolded form.

In an embodiment, when the first virtual item is in the placed state, the first virtual item will occupy at least one storage grid. When the first virtual item in the compressed form is in a placed state, the first virtual item occupies a first quantity of grids; and when the first virtual item in the unfolded form is in the placed state, the first virtual item occupies a second quantity of grids, the first quantity being less than the second quantity. For example, when the virtual backpack in the rolled-up form is in the placed state, the virtual backpack will occupy 1*2 grids; and when the virtual backpack in the unfolded form is in the placed state, the virtual backpack will occupy 4*4 grids.
Operation 640: Place the first virtual item according to a changed form of the first virtual item after the dragging process ends.

FIG. 7 is a flowchart of a virtual item-based interaction method according to an example embodiment of this disclosure. A description is provided by using an example in which the method is performed by the first terminal 310 shown in FIG. 3. The method includes the following operations:
Operation 710: Display a first virtual item.
Operation 720: Display a compression operation prompt in a case that the first virtual item is in an unfolded form in the dragging process of the first virtual item, the compression operation prompt being configured for prompting that a compression operation is supported in the dragging process and prompting a shortcut of the compression operation.

For example, a cursor of a mouse is controlled to fall on the first virtual item. In response to that a left mouse button receives a click operation, it is determined that the first virtual item is selected. Through continuous movement of the cursor, the first virtual item is controlled to move with the cursor. In the process in which the first virtual item moves along with movement of the cursor, the first virtual item may be in the unfolded form. For example, a virtual backpack is in the unfolded form or virtual clothes are the unfolded form.

For the first virtual item in the unfolded form, a compression operation prompt will be displayed on the interface. The compression operation prompt is configured for prompting that a compression operation is supported in the dragging process and prompting a shortcut of the compression operation. That is, this embodiment provides a real-time operation prompt. The operation prompt will change in real time based on the form of the first virtual item. The first virtual item is in the unfolded form, then the compression operation prompt is displayed.

In an embodiment, the compression operation prompt includes a compression text region and a compression pattern region. The compression text region is configured for prompting that a compression operation is supported in the dragging process, and the compression pattern region is configured for prompting a shortcut of the compression operation. For example, text “Compress” is displayed in the compression text region, indicating that the compression operation is supported in the dragging process. A key “F” is displayed in the compression pattern region, indicating that the compression operation can be triggered by pressing the “F” key on the keyboard.

In an embodiment, the compression operation prompt moves along with dragging of the first virtual item, and the compression operation prompt is located near the first virtual item. In some embodiments, the compression operation prompt is located at the upper part, at the lower part, at the left side, at the right side, in the upper left corner, in the upper right corner, in the lower left corner, in the lower right corner, or the like of the first virtual item.

In an embodiment, the compression operation prompt includes a compression operation animation, for example, playing an animation of pressing the “F” key on the keyboard with a finger to compress a backpack in the unfolded form.
Operation 730: Change the first virtual item from the unfolded form to a compressed form in response to receiving the compression operation corresponding to the compression operation prompt.

For example, in response to receiving an operation of triggering the “F” key on the keyboard, the virtual backpack is changed from the unfolded form to the rolled-up form.

For example, in response to receiving an operation of triggering the “F” key on the keyboard, the virtual clothes are changed from the unfolded form to the folded form.

In an embodiment, when the first virtual item is in the placed state, the first virtual item will occupy at least one storage grid. When the first virtual item in the compressed form is in a placed state, the first virtual item occupies a first quantity of grids; and when the first virtual item in the unfolded form is in the placed state, the first virtual item occupies a second quantity of grids, the first quantity being less than the second quantity. For example, when the virtual backpack in the rolled-up form is in the placed state, the virtual backpack will occupy 1*2 grids; and when the virtual backpack in the unfolded form is in the placed state, the virtual backpack will occupy 4*4 grids.
Operation 740: Place the first virtual item according to a changed form of the first virtual item after the dragging process ends.

In an embodiment, the first virtual item is a virtual item with a storage capability, and the first virtual item stores a second virtual item therein. After the dragging process ends, the first virtual item is placed according to the changed form of the first virtual item and the second virtual item is placed separately.

For example, the virtual backpack is dragged from the character wearing region and placed in the virtual warehouse. Before the dragging, the virtual backpack in the character wearing region further stores items such as water, bandages, and candies. In the dragging process, a roll-up operation is performed on the virtual backpack, and the virtual backpack is placed in a 1*2 grid region in the virtual warehouse; and the items such as water, bandages, and candies are taken out separately and also placed in the virtual warehouse.

In an embodiment, the second virtual item is placed according to a preset placement rule. For example, after the dragging ends, a target container is searched for an empty region for automatic placement. Alternatively, a source container is searched for an empty region for automatic placement.

For example, the virtual backpack is dragged from a first virtual warehouse and placed in a second virtual warehouse. Before the dragging, the virtual backpack in the character wearing region further stores items such as water, bandages, and candies. In the dragging process, a roll-up operation is performed on the virtual backpack. After the dragging ends, the items such as water, bandages, and candies are placed in the second virtual warehouse or still placed in the first virtual warehouse.

In some embodiments, the first virtual warehouse may be a warehouse corresponding to a first character, and the second virtual warehouse may be a warehouse corresponding to a second character. The second character is a virtual character mastered by the first terminal.

That is, the foregoing embodiment provides a placement solution for the first virtual item and the second virtual item in a case that the first virtual item is moved and compressed, and the first virtual item stores the second virtual item.

In an embodiment, a confirmation pop-up window is displayed, the confirmation pop-up window including a first option, the first option being configured for confirming emptying of the second virtual item in the first virtual item; and in response to that the first option receives a triggering operation, it is determined that after the dragging process ends, the first virtual item is placed according to the changed form of the first virtual item and the second virtual item is placed separately.

For example, when a roll-up operation is performed on the virtual backpack in the dragging process, if there are items in the virtual backpack, a secondary confirmation pop-up window will be triggered after the dragging process ends. The secondary confirmation pop-up window is configured for asking the user whether to empty the items in the backpack and move the emptied items to the warehouse. If the user selects to agree, the backpack will be emptied and rolled up; and if the user selects to cancel, the roll-up operation will be canceled.

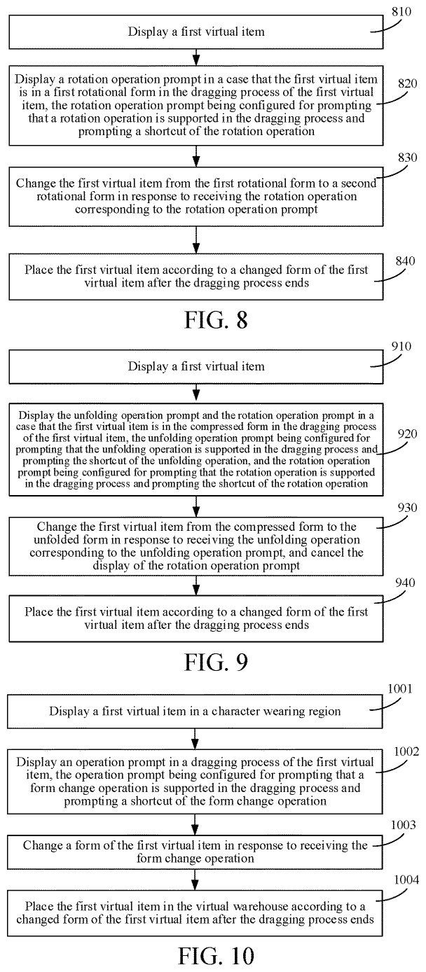

FIG. 8 is a flowchart of a virtual item-based interaction method according to an example embodiment of this disclosure. A description is provided by using an example in which the method is performed by the first terminal 310 shown in FIG. 3. The method includes the following operations:
Operation 810: Display a first virtual item.
Operation 820: Display a rotation operation prompt in a case that the first virtual item is in a first rotational form in the dragging process of the first virtual item, the rotation operation prompt being configured for prompting that a rotation operation is supported in the dragging process and prompting a shortcut of the rotation operation.

For example, a cursor of a mouse is controlled to fall on the first virtual item. In response to that a left mouse button receives a click operation, it is determined that the first virtual item is selected. Through continuous movement of the cursor, the first virtual item is controlled to move with the cursor. In the process in which the first virtual item moves along with movement of the cursor, the first virtual item may be in a rotatable state.

The first rotational form refers to a rotational posture of the first virtual item before rotation. For example, the first rotational form refers to an upright form, a lying-flat form, or the like of the first virtual item before rotation. The first rotational form is configured for representing that the first virtual item is in a rotatable state. For the first virtual item in the first rotational form, a rotation operation prompt will be displayed on the interface. The rotation operation prompt is configured for prompting that a rotation operation is supported in the dragging process and prompting a shortcut of the rotation operation. That is, this embodiment provides a real-time operation prompt. The operation prompt will change in real time based on the form of the first virtual item. If the first virtual item is in the rotatable state, the rotation operation prompt is displayed.

In an embodiment, the rotation operation prompt includes a rotation text region and a rotation pattern region. The rotation text region is configured for prompting that a rotation operation is supported in the dragging process, and the rotation pattern region is configured for prompting a shortcut of the rotation operation. For example, text “Rotate” is displayed in the rotation text region, indicating that the rotation operation is supported in the dragging process. A key “R” is displayed in the rotation pattern region, indicating that the rotation operation can be triggered by pressing the “R” key on the keyboard.

In an embodiment, the rotation operation prompt moves along with dragging of the first virtual item, and the rotation operation prompt is located near the first virtual item. In some embodiments, the rotation operation prompt is located at the upper part, at the lower part, at the left side, at the right side, in the upper left corner, in the upper right corner, in the lower left corner, in the lower right corner, or the like of the first virtual item.

In an embodiment, the rotation operation prompt includes a rotation operation animation, for example, playing an animation of pressing the “R” key on the keyboard with a finger to rotate a virtual backpack.
Operation 830: Change the first virtual item from the first rotational form to a second rotational form in response to receiving the rotation operation corresponding to the rotation operation prompt.

The second rotational form refers to a rotational posture of the first virtual item after rotation. For example, the second rotational form refers to an upright form, a lying-flat form, or the like of the first virtual item after rotation.

For example, in response to receiving an operation of triggering the “R” key on the keyboard, the virtual backpack is changed from the first rotational form to the second rotational form. For example, the first rotational form is the upright form of the virtual backpack, and the second rotational form is the lying-flat form of the virtual backpack.

In an embodiment, when the first virtual item is in the placed state, the first virtual item will occupy at least one storage grid. When the first virtual item in the first rotational form is in the placed state, the first virtual item occupies a p*q grid region; and when the first virtual item in the second rotational form is in the placed state, the first virtual item occupies a q*p grid region, the p*q grid region referring to a region with a length of p grids and a width of q grids, the q*p grid region referring to a region with a length of q grids and a width of p grids, and both p and q being positive integers.

For example, when the virtual backpack before rotation is in the placed state, the virtual backpack occupies a 1*2 grid region; and when the virtual backpack after rotation is in the placed state, the virtual backpack occupies a 2*1 grid region. That is, each time the rotation operation is performed, the quantities of grids occupied in the length and width dimensions will be exchanged.

In some embodiments, the rotation operation is an operation of rotating clockwise or rotating counterclockwise. In some embodiments, one rotation operation is performed on the virtual backpack in the upright form, and the virtual backpack in the upright form will be changed to a virtual backpack in the lying-flat form. The rotation operation is performed again, and the virtual backpack will return to the upright form. That is, two rotation operations correspond to one rotation cycle.
Operation 840: Place the first virtual item according to a changed form of the first virtual item after the dragging process ends.

FIG. 9 is a flowchart of a virtual item-based interaction method according to an example embodiment of this disclosure. A description is provided by using an example in which the method is performed by the first terminal 310 shown in FIG. 3. The method includes the following operations:
Operation 910: Display a First Virtual Item.
Operation 920: Display the unfolding operation prompt and the rotation operation prompt in a case that the first virtual item is in the compressed form in the dragging process of the first virtual item, the unfolding operation prompt being configured for prompting that the unfolding operation is supported in the dragging process and prompting the shortcut of the unfolding operation, and the rotation operation prompt being configured for prompting that the rotation operation is supported in the dragging process and prompting the shortcut of the rotation operation.

For example, a cursor of a mouse is controlled to fall on the first virtual item. In response to that a left mouse button receives a click operation, it is determined that the first virtual item is selected. Through continuous movement of the cursor, the first virtual item is controlled to move with the cursor. In the process in which the first virtual item moves along with movement of the cursor, the first virtual item may be in the compressed form. For example, a virtual backpack is in a rolled-up form or virtual clothes are in a folded form.

For the first virtual item in the compressed form, an unfolding operation prompt and a rotation operation prompt will be displayed on the interface. The unfolding operation prompt is configured for prompting that an unfolding operation is supported in the dragging process and prompting a shortcut of the unfolding operation. The rotation operation prompt is configured for prompting that a rotation operation is supported in the dragging process and prompting a shortcut of the rotation operation.

That is, this embodiment provides a real-time operation prompt. The operation prompt will change in real time based on the form of the first virtual item. The first virtual item is in the compressed form, then the unfolding operation prompt and the rotation operation prompt are displayed.
Operation 930: Change the first virtual item from the compressed form to the unfolded form in response to receiving the unfolding operation corresponding to the unfolding operation prompt, and cancel the display of the rotation operation prompt.

For example, in response to receiving an operation of triggering the “F” key on the keyboard, the virtual backpack is changed from the rolled-up form to the unfolded form.

For example, in response to receiving an operation of triggering the “F” key on the keyboard, the virtual clothes are changed from the folded form to the unfolded form.

In this embodiment, when the first virtual item is in the unfolded form, the rotation operation prompt is not displayed. This is because in the unfolded form, the volume of the first virtual item is relatively large, and the performance after rotation may not be ideal. In addition, in many designs, the unfolded first virtual item is a square and the first virtual item will occupy a square grid region. In this case, the rotation may not change the shape and may not affect the placement of the first virtual item.
Operation 940: Place the first virtual item according to a changed form of the first virtual item after the dragging process ends.

The virtual item-based interaction method provided in this disclosure may be applied to warehouse organization scenarios.

FIG. 10 is a flowchart of a virtual item-based interaction method according to an example embodiment of this disclosure. A description is provided by using an example in which the method is performed by the first terminal 310 shown in FIG. 3. The method includes the following operations:
Operation 1001: Display a first virtual item in a character wearing region.
Operation 1002: Display an operation prompt in a dragging process of the first virtual item, the operation prompt being configured for prompting that a form change operation is supported in the dragging process and prompting a shortcut of the form change operation.

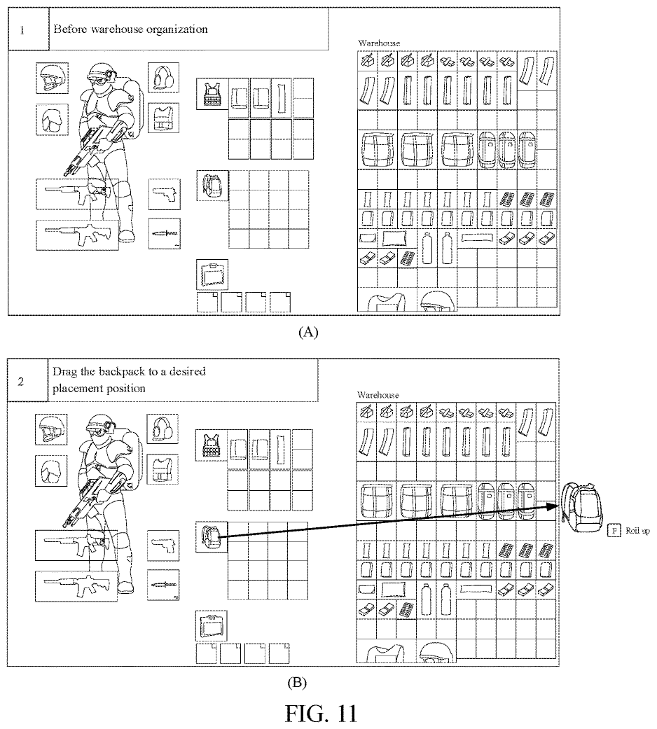

Referring to FIG. 11, the part (A) of FIG. 11 shows a schematic diagram of an interface before warehouse organization. In the part (A) of FIG. 11, the left is the character wearing region, and the right is a virtual warehouse. In this case, in the character wearing region, a virtual character wears a virtual backpack. In response to that the virtual backpack receives a dragging operation, the part (B) of FIG. 11 shows the virtual backpack in the dragging process. In this case, the virtual backpack is in an unfolded form.

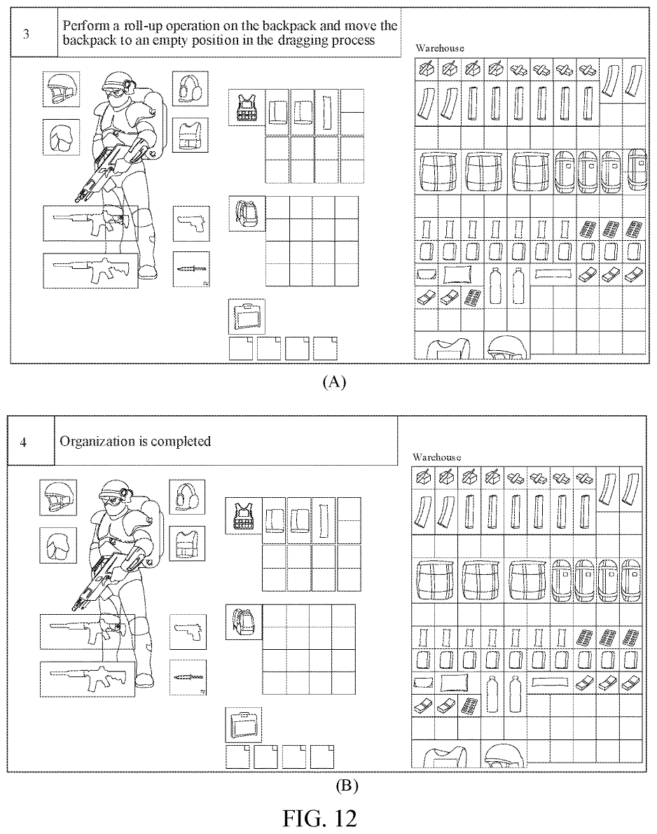

Referring to FIG. 12, the part (A) of FIG. 12 shows the virtual backpack after a roll-up operation is performed in the dragging process, and shows dragging the virtual backpack to an empty position in the warehouse. The part (B) of FIG. 12 shows the virtual backpack placed in the warehouse after the dragging ends.

Referring to FIG. 11 and FIG. 12, during warehouse organization, the user intends to place different types of items neatly in separate rows. The user manually partitions a storage region of the warehouse, and unifiedly places backpack-type items in the same row, with exactly two empty grids on the rightmost of the row, enough for the user to fold up a backpack with a 4*4 shape and switch the backpack to a 1*2 shape for placement.

In the related art, the user needs to drag the backpack to a region large enough to accommodate an item with a 4*4 shape, subsequently select the backpack, choose “roll up” in pop-up options and switch the backpack to a 1*2 shape, and then drag the backpack changed into a 1*2 shape to a region in which the backpack will be finally placed. In this case, the interaction operations are relatively numerous and not smooth.

By using the solution in this disclosure, according to the operations shown in FIG. 11 and FIG. 12, the user can complete the warehouse organization process from process 1 to process 4 shown in FIG. 11 and FIG. 12 by performing, in an example, two simple operations:
Operation 1: Drag the backpack to a desired placement position in the warehouse.
Operation 2: According to a roll-up operation prompt on the backpack in the dragging process, use a default or user-defined shortcut key to roll up the backpack, and then stop dragging.
Operation 1003: Change a form of the first virtual item in response to receiving the form change operation.

The first virtual item is changed from a compressed form to an unfolded form.
Operation 1004: Place the first virtual item in the virtual warehouse according to a changed form of the first virtual item after the dragging process ends.

The virtual item-based interaction method provided in this disclosure may be applied to an item adaptation scenario. In the scenario, a form of an item is changed, so that the form of the item matches a shape of an empty region.

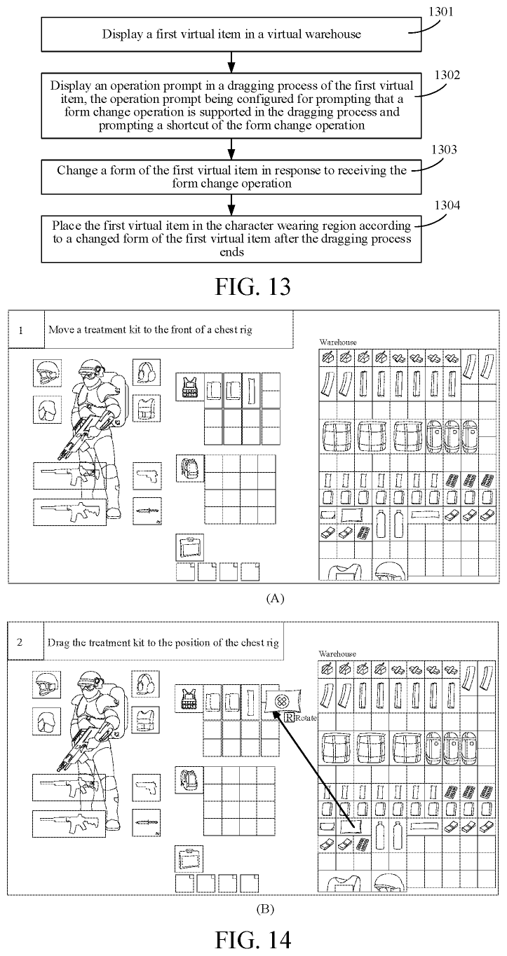

FIG. 13 is a flowchart of a virtual item-based interaction method according to an example embodiment of this disclosure. A description is provided by using an example in which the method is performed by the first terminal 310 shown in FIG. 3. The method includes the following operations:
Operation 1301: Display a first virtual item in a virtual warehouse.
Operation 1302: Display an operation prompt in a dragging process of the first virtual item, the operation prompt being configured for prompting that a form change operation is supported in the dragging process and prompting a shortcut of the form change operation.

Referring to FIG. 14, the part (A) of FIG. 14 shows a schematic diagram of an interface on which a mobile treatment kit is placed in front of a chest rig. In the part (A) of FIG. 14, the left is a character wearing region, and the right is the virtual warehouse. In this case, the virtual warehouse stores a treatment kit. In response to that the treatment kit receives a dragging operation, the part (B) of FIG. 14 shows the treatment kit in the dragging process. In this case, a shape of the treatment kit is 2*1 and the unit is a storage grid.

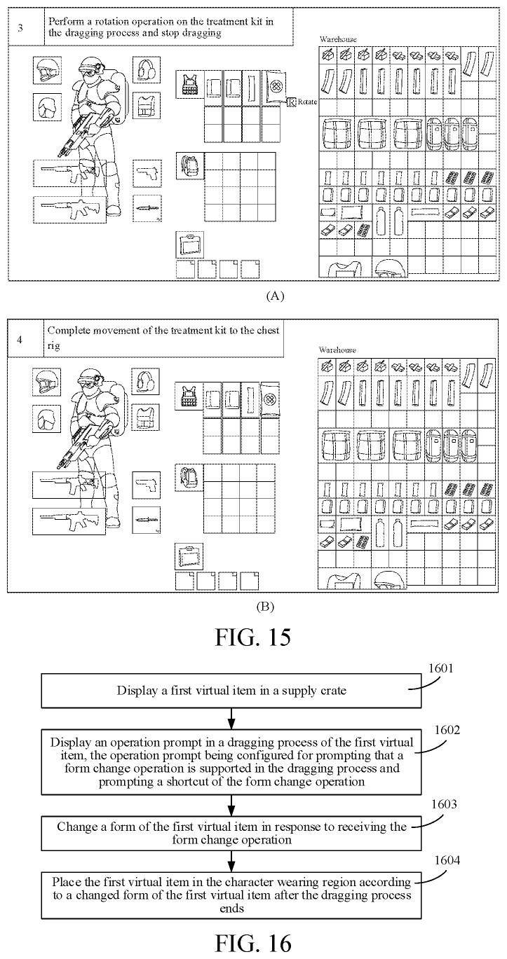

Referring to FIG. 15, the part (A) of FIG. 15 shows the treatment kit after a rotation operation is performed in the dragging process, and in this case, the shape of the treatment kit is 2*1. The part (B) of FIG. 15 shows the treatment kit placed in the chest rig after the dragging ends.

Referring to FIG. 14 and FIG. 15, when placing the treatment kit, the user intends to move the treatment kit with a 2*1 shape in the virtual warehouse to the rightmost 1*2 empty grids in the first row of the chest rig storage region on the character.

In the related art, the user needs to drag the treatment kit to an empty region with a shape larger than 2*2, where the unit is a storage grid. Subsequently, after selecting the treatment kit, the user selects “rotate” in pop-up options to switch the shape of the treatment kit to 1*2, and then drags the changed treatment kit to a position in which the treatment kit will be finally placed within the chest rig storage region. In this case, the interaction operations are relatively numerous and not smooth.

By using the solution in this disclosure, according to the operations shown in FIG. 14 and FIG. 15, the user can complete the item adaptation solution from process 1 to process 4 in the figures by performing, in an example, two simple operations:
Operation 1: Drag the treatment kit to the rightmost empty grids in the first row of the chest rig.
Operation 2: According to a rotation operation prompt on the treatment kit in the dragging process, use a default or user-defined shortcut key to rotate the treatment kit, and then stop dragging.
Operation 1303: Change a form of the first virtual item in response to receiving the form change operation.

The first virtual item is changed from a compressed form to an unfolded form.
Operation 1304: Place the first virtual item in the character wearing region according to a changed form of the first virtual item after the dragging process ends.

The virtual item-based interaction method provided in this disclosure may be applied to item acquisition scenarios.

FIG. 16 is a flowchart of a virtual item-based interaction method according to an example embodiment of this disclosure. A description is provided by using an example in which the method is performed by the first terminal 310 shown in FIG. 3. The method includes the following operations:
Operation 1601: Display a first virtual item in a supply crate.
Operation 1602: Display an operation prompt in a dragging process of the first virtual item, the operation prompt being configured for prompting that a form change operation is supported in the dragging process and prompting a shortcut of the form change operation.

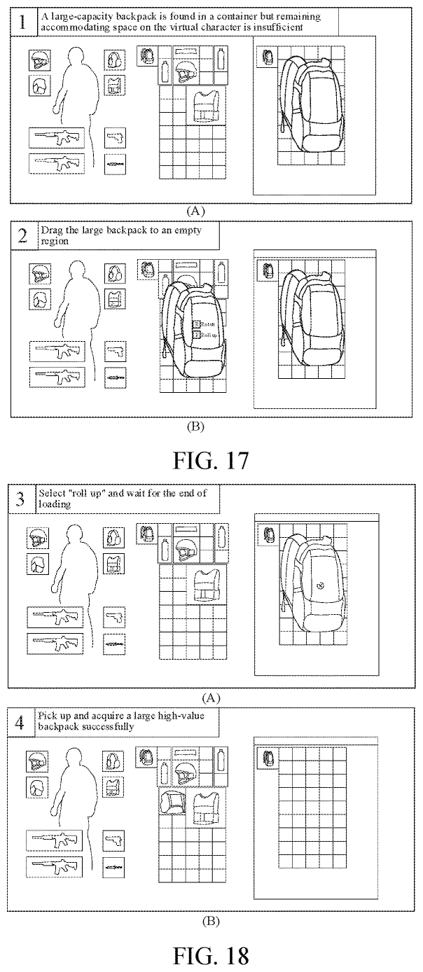

Referring to FIG. 17, the part (A) of FIG. 17 shows a schematic diagram of an interface on which a large-capacity backpack is found in the supply crate but remaining accommodating space on the virtual character is insufficient. In the part (A) of FIG. 17, the left is a character wearing region, and the right is the supply crate. In this case, the supply crate stores a large-capacity backpack. In response to that the large-capacity backpack receives a dragging operation, the part (B) of FIG. 17 shows the large-capacity backpack in the dragging process.

Referring to FIG. 18, the part (A) of FIG. 18 shows the large-capacity backpack during loading after a roll-up operation is performed in the dragging process, and the part (B) of FIG. 18 shows a schematic diagram of placing the rolled-up large-capacity backpack into the backpack on the virtual character after the loading is completed.

In some embodiments, a bag nesting operation, that is, placing one backpack inside another backpack, is supported. The large-capacity backpack often has very high value. In a case that the virtual character wears a backpack, if a user finds a large-capacity backpack in a battle, the user may still take the large-capacity backpack away. In the related art, either a layer-upon-layer nesting interaction method in which a backpack is nested in a backpack can be used, or bag nesting is prohibited, and the virtual character may be allowed to carry one backpack at most in a battle. The former results in that interaction of the user using items in the innermost backpack after bag nesting becomes cumbersome, while the latter may make the user feel like missing out on benefits.

Referring to FIG. 17 and FIG. 18, the solution provided in this disclosure not only allows bag nesting, but also allows the user to take away a high-value and large-capacity backpack through a roll-up operation in a manner of sacrificing the minimum quantity of grids. This disclosure helps the user learn and understand the game's bag nesting gameplay and competition through display of a compression operation prompt in the dragging process, thereby providing larger competition space and deeper gameplay.
Operation 1603: Change a form of the first virtual item in response to receiving the form change operation.

The first virtual item is changed from a compressed form to an unfolded form.
Operation 1604: Place the first virtual item in the character wearing region according to a changed form of the first virtual item after the dragging process ends.

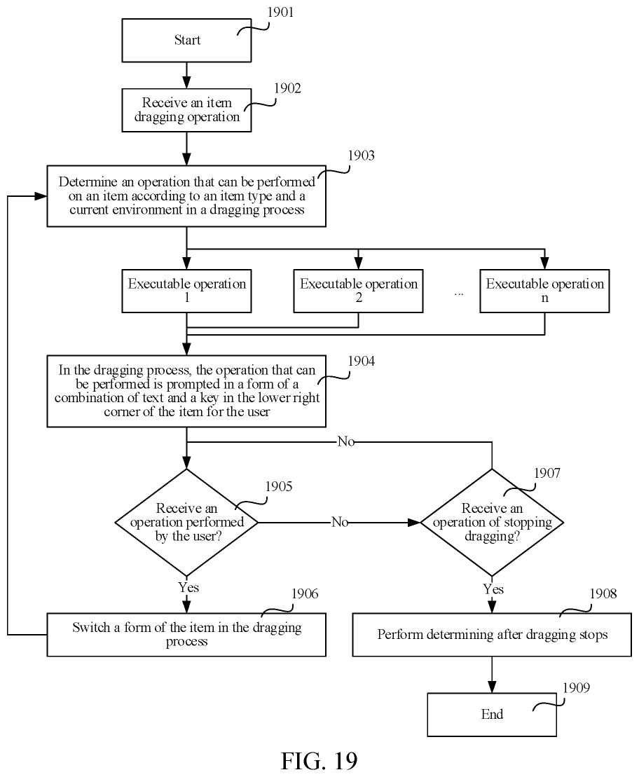

FIG. 19 is a flowchart of a virtual item-based interaction method according to an example embodiment of this disclosure. A description is provided by using an example in which the method is performed by the first terminal 310 shown in FIG. 3. The method includes the following operations:
Operation 1901: Start.
Operation 1902: Receive an item dragging operation.
Operation 1903: Determine an operation that can be performed on an item according to an item type and a current environment in a dragging process.

When a user drags an item, the terminal jointly determines, according to the type of the dragged item and the current environmental conditions, an operation that can be performed on the item in the dragging process and that needs to prompt.
Operation 1904: In the dragging process, the operation that can be performed is prompted in a form of a combination of text and a key in the lower right corner of the item for the user.

The terminal displays the operation that can be performed by the user in the lower right corner of the item in a form of a shortcut key and prompt text.
Operation 1905: Receive an operation performed by the user?

The terminal determines whether an operation performed by the user has been received. If yes, operation 1906 is performed; or if not, operation 1907 is performed.
Operation 1906: Switch a form of the item in the dragging process.

If the user performs an operation according to the shortcut key and the prompt text, the form of the item in the dragging process is switched according to the corresponding operation. After the switching, the process returns to operation 1903. That is, after the switching, the terminal will determine an operation that can be performed on the item according to the item type after the switching and the current environment.

In an embodiment, when outside a battle, if the user performs a roll-up operation on a backpack in a dragging process, if there are items in the backpack, after the user stops dragging, a secondary confirmation pop-up window will be triggered to ask the user whether to empty the items in the backpack and move the emptied items to a warehouse. If the user selects to agree, the backpack will be emptied and rolled up; and if the user selects to cancel, the roll-up operation will be canceled.
Operation 1907: Receive an operation of stopping dragging?

The terminal determines whether an operation of stopping dragging has been received. If yes, operation 1908 is performed; or if not, operation 1905 is performed.
Operation 1908: Perform determining after dragging stops.

The terminal determines whether the item can be placed in a current storage position according to the form of the item after dragging stops. If the item can be placed, the item is placed in the current storage position; if the item is not placeable, the item is not placed in the current storage position. In some embodiments, the item is placed back in an original storage position.
Operation 1909: End.

Based on the above, the foregoing embodiment can help the user quickly learn and master an operation that can be performed on a first virtual item in a dragging process with low operating costs, and still quickly understand its available or key operations after a form of the first virtual item changes in the dragging process in some games or applications. Meanwhile, before the dragging operation ends, the user can perceive a result after the dragging ends.

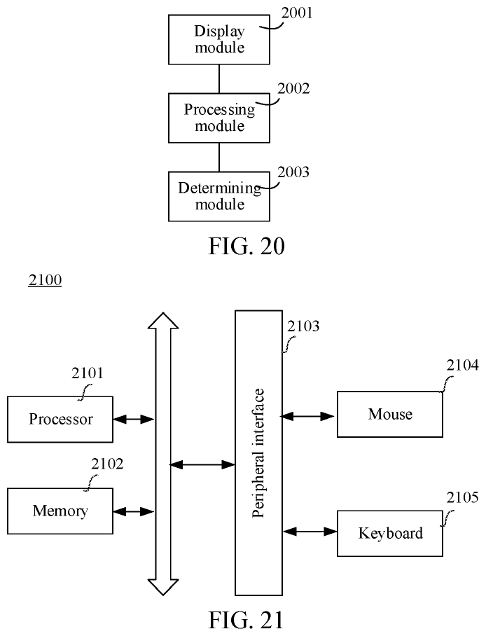

FIG. 20 is a structural block diagram of a virtual item-based interaction apparatus according to an example embodiment of this disclosure. The apparatus includes:
a display module 2001, configured to display a first virtual item;
the display module 2001 being further configured to display an operation prompt in a dragging process of the first virtual item, the operation prompt being configured for prompting that a form change operation is supported in the dragging process and prompting a shortcut of the form change operation;
the display module 2001 being further configured to change a form of the first virtual item in response to receiving the form change operation; and
a processing module 2002, configured to place the first virtual item according to a changed form of the first virtual item after the dragging process ends.

In an optional embodiment, the display module 2001 is further configured to display n operation prompts corresponding to a first form in the dragging process of the first virtual item, the n operation prompts being configured for prompting that n form change operations are supported in the dragging process and prompting shortcuts in a one-to-one correspondence with the n form change operations, n being a positive integer; and
change the first virtual item from the first form to a second form in response to receiving any one of the n form change operations.

In an optional embodiment, the display module 2001 is further configured to display an unfolding operation prompt in a case that the first virtual item is in a compressed form in the dragging process of the first virtual item, the unfolding operation prompt being configured for prompting that an unfolding operation is supported in the dragging process and prompting a shortcut of the unfolding operation; and
change the first virtual item from the compressed form to the unfolded form in response to receiving the unfolding operation corresponding to the unfolding operation prompt.

In an optional embodiment, the display module 2001 is further configured to display a compression operation prompt in a case that the first virtual item is in an unfolded form in the dragging process of the first virtual item, the compression operation prompt being configured for prompting that a compression operation is supported in the dragging process and prompting a shortcut of the compression operation; and
change the first virtual item from the unfolded form to a compressed form in response to receiving the compression operation corresponding to the compression operation prompt.

In an optional embodiment, when the first virtual item in the compressed form is in a placed state, the first virtual item occupies a first quantity of grids; and when the first virtual item in the unfolded form is in the placed state, the first virtual item occupies a second quantity of grids, the first quantity being less than the second quantity.

In an optional embodiment, the first virtual item is a virtual item with a storage capability, and the first virtual item stores a second virtual item therein; and the display module 2001 is further configured to place the first virtual item according to the changed form of the first virtual item and place the second virtual item separately after the dragging process ends.

In an optional embodiment, the display module 2001 is further configured to display a confirmation pop-up window, the confirmation pop-up window including a first option, the first option being configured for confirming emptying of the second virtual item in the first virtual item; and
the apparatus further includes a determining module 2003. The determining module 2003 is configured to determine, in response to that the first option receives a triggering operation, to place the first virtual item according to the changed form of the first virtual item and to place the second virtual item separately after the dragging process ends.

In an optional embodiment, the display module 2001 is further configured to display a rotation operation prompt in a case that the first virtual item is in a first rotational form in the dragging process of the first virtual item, the rotation operation prompt being configured for prompting that a rotation operation is supported in the dragging process and prompting a shortcut of the rotation operation; and
change the first virtual item from the first rotational form to a second rotational form in response to receiving the rotation operation corresponding to the rotation operation prompt.

In an optional embodiment, when the first virtual item in the first rotational form is in the placed state, the first virtual item occupies a p*q grid region; and when the first virtual item in the second rotational form is in the placed state, the first virtual item occupies a q*p grid region,
the p*q grid region referring to a region with a length of p grids and a width of q grids, the q*p grid region referring to a region with a length of q grids and a width of p grids, and both p and q being positive integers.

In an optional embodiment, the display module 2001 is further configured to display the unfolding operation prompt and the rotation operation prompt in a case that the first virtual item is in the compressed form in the dragging process of the first virtual item, the unfolding operation prompt being configured for prompting that the unfolding operation is supported in the dragging process and prompting the shortcut of the unfolding operation, and the rotation operation prompt being configured for prompting that the rotation operation is supported in the dragging process and prompting the shortcut of the rotation operation;
change the first virtual item from the compressed form to the unfolded form in response to receiving the unfolding operation corresponding to the unfolding operation prompt; and
cancel the display of the rotation operation prompt.

In an optional embodiment, the operation prompt moves along with dragging of the first virtual item, and the operation prompt is located near the first virtual item.

In an optional embodiment, the display module 2001 is further configured to display the first virtual item in a first container; and the processing module 2002 is further configured to place the first virtual item in a second container according to the changed form of the first virtual item after the dragging process ends.

In an optional embodiment, capacities of the first container and the second container are both measured by a quantity of grids, and each container includes a plurality of grids; and a volume of the first virtual item is measured by a quantity of grids, and when the first virtual item is in the placed state, the first virtual item occupies at least one grid.

In an optional embodiment, the first container is a storage space of a third virtual item, the third virtual item is a virtual item with a storage capability, and the second container is a storage space designed by a game system.

In an optional embodiment, the second container is a storage space of a third virtual item, the third virtual item is a virtual item with a storage capability, and the first container is a storage space designed by a game system.

In an optional embodiment, the first container is a slot dedicated for items of a first category, and the first virtual item belongs to the first category; a capacity of the second container is measured by a quantity of grids, and the second container includes a plurality of grids; and a volume of the first virtual item is measured by a quantity of grids, and when the first virtual item is in the placed state, the first virtual item occupies at least one grid.

In an optional embodiment, the display module 2001 is further configured to display the first virtual item in a first position in the first container; and
place the first virtual item in a second position in the first container according to the changed form of the first virtual item after the dragging process ends.

Based on the above, an operation prompt is displayed in the dragging process of the first virtual item. In this disclosure, the operation prompt will be used to prompt the user that a form change operation can be performed in the dragging process, and the shortcut of the form change operation will be used to inform the user of existence of the form change operation and a manner of triggering the form change operation, without the need for the user to explore the form change operation, thereby reducing the user's learning cost.

FIG. 21 shows a structural block diagram of a computer device 2100 according to an example embodiment of this disclosure. The computer device 2100 may be a portable mobile terminal, such as a smartphone, a tablet computer, a moving picture experts group audio layer III (MP3) player, or a moving picture experts group audio layer IV (MP4) player. The computer device 2100 may be further referred to as another name such as user equipment, a portable terminal, or a head-mounted computer device.

Generally, the computer device 2100 includes a processor 2101 and a memory 2102.

The processor 2101 may include one or more processing cores, for example, the processor 2101 may be a 4-core processor or an 8-core processor. The processor 2101 may be implemented by using at least one hardware form of digital signal processing (DSP), a field-programmable gate array (FPGA), and a programmable logic array (PLA). The processor 2101 may alternatively include a main processor and a coprocessor. The main processor is a processor configured to process data in an awake state, also referred to as a central processing unit (CPU), and the coprocessor is a low-power processor configured to process data in a standby state. In some embodiments, the processor 2101 may be integrated with a graphics processing unit (GPU). The GPU is configured to render and draw content that needs to be displayed on a display screen. In some embodiments, the processor 2101 may further include an artificial intelligence (AI) processor. The AI processor is configured to process a computing operation related to machine learning.

The memory 2102 may include one or more computer-readable storage media. The computer-readable storage medium may be tangible and non-transient. The memory 2102 may further include a high-speed random access memory and a non-volatile memory such as one or more magnetic disk storage devices and a flash storage device. In some embodiments, the non-transitory computer-readable storage medium in the memory 2102 is configured to store at least one instruction, and the at least one instruction is configured to be executed by the processor 2101 to implement the virtual item-based interaction method provided in the embodiments of this disclosure.

In some embodiments, the computer device 2100 further alternatively includes a peripheral interface 2103 and at least one peripheral. In an example, the peripheral includes: at least one of a mouse 2104, and a keyboard 2105. The peripheral interface 2103 may be configured to connect at least one input/output (I/O)-related peripheral to the processor 2101 and the memory 2102. In some embodiments, the processor 2101, the memory 2102, and the peripheral interface 2103 are integrated on the same chip or circuit board. In some other embodiments, any one or two of the processor 2101, the memory 2102, and the peripheral interface 2103 may be implemented on a separate chip or circuit board, which is not limited in this embodiment.

A person skilled in the art may understand that the structure shown in FIG. 21 does not constitute any limitation on the computer device 2100, and the computer device may include more or fewer components than those shown in the figure, or some components may be combined, or a different component deployment may be used.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

An embodiment of this disclosure further provides a non-transitory computer-readable storage medium, storing a computer program, the computer program being configured to being executed by a computer device, to implement the foregoing virtual item-based interaction method.

In some embodiments, the non-transitory computer-readable storage medium may include: a read-only memory (ROM), a random access memory (RAM), a solid state drive (SSD), an optical disc, or the like. The RAM may include a resistance random access memory (ReRAM) and a dynamic random access memory (DRAM).

This disclosure provides a computer program product or a computer program. The computer program product or the computer program includes computer instructions, the computer instructions being stored in a non-transitory computer-readable storage medium. A processor of a computer device reads the computer instructions from the non-transitory computer-readable storage medium, and executes the computer instructions, to cause the computer device to perform the virtual item-based interaction method provided in the foregoing method embodiments.

What is claimed is:

1. A virtual item-based interaction method, comprising:
displaying a first virtual item;
displaying an operation prompt while the first virtual item is dragged, the operation prompt indicating that a form change operation is supported while the first virtual item is dragged and indicating a trigger for the form change operation;
changing a form of the first virtual item based on the form change operation being triggered; and
placing the first virtual item according to a changed form of the first virtual item.

2. The method according to claim 1, wherein the displaying the operation prompt comprises:
displaying n operation prompts corresponding to a first form while the first virtual item is dragged, the n operation prompts indicating that n form change operations are supported while the first virtual item is dragged and indicating triggers in a one-to-one correspondence with the n form change operations, n being a positive integer; and
the changing the form of the first virtual item comprises:
changing the first virtual item from the first form to a second form based on one of the n form change operations being triggered.

3. The method according to claim 2, wherein the displaying n operation prompts comprises:
displaying an unfolding operation prompt when the first virtual item is in a compressed form and while the first virtual item is dragged, the unfolding operation prompt indicating that an unfolding operation is supported while the first virtual item is dragged and indicating a trigger for the unfolding operation; and
the changing the first virtual item from the first form to the second form comprises:
changing the first virtual item from the compressed form to an unfolded form based on the unfolding operation corresponding to the unfolding operation prompt being triggered.

4. The method according to claim 2, wherein the displaying n operation prompts comprises:
displaying a compression operation prompt when the first virtual item is in an unfolded form while the first virtual item is dragged, the compression operation prompt indicating that a compression operation is supported while the first virtual item is dragged and indicating a trigger for the compression operation; and
the changing the first virtual item from the first form to a second form comprises:
changing the first virtual item from the unfolded form to a compressed form based on the compression operation corresponding to the compression operation prompt being triggered.

5. The method according to claim 4, wherein
when the first virtual item in the compressed form is in a placed state, the first virtual item occupies a first quantity of grids; and
when the first virtual item in the unfolded form is in the placed state, the first virtual item occupies a second quantity of grids, the first quantity being less than the second quantity.

6. The method according to claim 4, wherein the first virtual item is a virtual item with a storage capability, and the first virtual item stores a second virtual item; and
the placing the first virtual item comprises:
placing the first virtual item according to the changed form of the first virtual item and placing the second virtual item separately.

7. The method according to claim 6, further comprising:
displaying a confirmation pop-up window, the confirmation pop-up window indicating a first option, the first option confirming emptying of the second virtual item in the first virtual item; and
determining, based on the first option being confirmed, to place the first virtual item according to the changed form of the first virtual item and to place the second virtual item separately.

8. The method according to claim 2, wherein the displaying n operation prompts comprises:
displaying a rotation operation prompt when the first virtual item is in a first rotational form while the first virtual item is dragged, the rotation operation prompt indicating that a rotation operation is supported while the first virtual item is dragged and indicating a trigger for the rotation operation; and
the changing the first virtual item from the first form to the second form comprises:
changing the first virtual item from the first rotational form to a second rotational form based on the rotation operation corresponding to the rotation operation prompt being triggered.

9. The method according to claim 8, wherein
when the first virtual item in the first rotational form is in a placed state, the first virtual item occupies a p*q grid region; and
when the first virtual item in the second rotational form is in the placed state, the first virtual item occupies a q*p grid region, the p*q grid region referring to a region with a length of p grids and a width of q grids, the q*p grid region referring to a region with a length of q grids and a width of p grids, and both p and q being positive integers.

10. The method according to claim 8, wherein the displaying n operation prompts comprises:
displaying an unfolding operation prompt and the rotation operation prompt when the first virtual item is in a compressed form while the first virtual item is dragged, the unfolding operation prompt indicating that an unfolding operation is supported while the first virtual item is dragged and indicating a trigger for the unfolding operation, and the rotation operation prompt indicating the rotation operation is supported while the first virtual item is dragged and indicating the trigger for the rotation operation;
the changing the first virtual item from the first form to a second form comprises:
changing the first virtual item from the compressed form to an unfolded form based on the unfolding operation corresponding to the unfolding operation prompt being triggered; and
the method further comprises:
canceling the display of the rotation operation prompt.

11. The method according to claim 1, wherein the operation prompt moves along with the first virtual item as the first virtual item is dragged.

12. The method according to claim 1, wherein the displaying the first virtual item comprises:
displaying the first virtual item in a first container; and
the placing the first virtual item comprises:
placing the first virtual item in a second container according to the changed form of the first virtual item.

13. The method according to claim 12, wherein
capacities of the first container and the second container are both measured by a quantity of grids, and each container comprises a plurality of grids; and
a volume of the first virtual item is measured by a quantity of grids, and when the first virtual item is in a placed state, the first virtual item occupies at least one grid.

14. The method according to claim 13, wherein
the first container comprises a storage space of a third virtual item, the third virtual item comprises a virtual item with a storage capability, and the second container comprises a storage space designed by a game system; or
the second container is a storage space of a third virtual item, the third virtual item comprises a virtual item with a storage capability, and the first container comprises a storage space in a game.

15. The method according to claim 12, wherein
the first container is a slot dedicated for items of a first category, and the first virtual item belongs to the first category;
a capacity of the second container is measured by a quantity of grids, and the second container comprises a plurality of grids; and
a volume of the first virtual item is measured by a quantity of grids, and when the first virtual item is in a placed state, the first virtual item occupies at least one grid.

16. The method according to claim 12, wherein the displaying a first virtual item comprises:
displaying the first virtual item in a first position in the first container; and
the placing the first virtual item comprises:
placing the first virtual item in a second position in the first container according to the changed form of the first virtual item.

17. A virtual item-based interaction apparatus, comprising:
processing circuitry configured to:
display a first virtual item;
display an operation prompt while the first virtual item is dragged, the operation prompt indicating that a form change operation is supported while the first virtual item is dragged and indicating a trigger for the form change operation;
change a form of the first virtual item based on the form change operation being triggered; and
place the first virtual item according to a changed form of the first virtual item.

18. The virtual item-based interaction apparatus according to claim 17, wherein
the display the operation prompt comprises:
display n operation prompts corresponding to a first form while the first virtual item is dragged, the n operation prompts indicating that n form change operations are supported while the first virtual item is dragged and indicating triggers in a one-to-one correspondence with the n form change operations, n being a positive integer; and
the change the form of the first virtual item comprises:
change the first virtual item from the first form to a second form based on one of the n form change operations being triggered.

19. The virtual item-based interaction apparatus according to claim 18, wherein
the display n operation prompts comprises:
display an unfolding operation prompt when the first virtual item is in a compressed form and while the first virtual item is dragged, the unfolding operation prompt indicating that an unfolding operation is supported while the first virtual item is dragged and indicating a trigger for the unfolding operation; and
the change the first virtual item from the first form to the second form comprises:
change the first virtual item from the compressed form to an unfolded form based on the unfolding operation corresponding to the unfolding operation prompt being triggered.

20. A non-transitory computer-readable storage medium storing instructions which when executed by a processor cause the processor to perform:
displaying a first virtual item;
displaying an operation prompt while the first virtual item is dragged, the operation prompt indicating that a form change operation is supported while the first virtual item is dragged and indicating a trigger for the form change operation;
changing a form of the first virtual item based on the form change operation being triggered; and
placing the first virtual item according to a changed form of the first virtual item.
